(19) United States
(12) Patent Application Publication
(10) Pub. No.: US 2022/0192808 A1
(43) Pub. Date: Jun. 23, 2022

(54) DEVICE FOR CLEANING A SET OF TEETH AND CLEANING MEMBER FOR USE THEREIN

(71) Applicant: Marinus LODDE, Et Almelo (NL)

(72) Inventor: Marinus LODDE, Et Almelo (NL)

(21) Appl. No.: 17/595,218

(22) PCT Filed: Dec. 6, 2018
(86) PCT No.: PCT/NL2018/050817

§ 371 Date: Nov. 11, 2021

(51) Int. Cl. A61C 17/22

(52) U.S. Cl. CPC A61C 17/222; A61C 17/225; A61C 17/221; A61C 17/224

(57) ABSTRACT

The invention relates to a device for cleaning a set of teeth, comprising a handle, a drive arranged on or in the handle and a cleaning member connected movably to the handle and drivably to the drive.

A protection against overloading can here be arranged between the cleaning member and the drive. The overload protection can comprise a slipping coupling, for instance a magnetic coupling.

In addition or instead, the drive can comprise an electric motor and a rechargeable battery, wherein the rechargeable battery can be connected to a USB connection on the handle.

The invention further relates to a cleaning member which is evidently intended for application in such a device.

The invention relates to a device for cleaning a set of teeth, comprising a handle, a drive arranged on or in the handle and a cleaning member connected movably to the handle and drivably to the drive. Such a teeth-cleaning device is known in many variants.

Most widespread are electrically driven toothbrushes, which are generally formed by a handle in which a small electric motor is arranged, and a brush arranged releasably thereon. The brush is set into a rotating or reciprocal movement by the drive.

Additionally also known are electrically driven flossing devices, which are often based on an electric toothbrush, wherein instead of the usual toothbrush a flossing member is arranged on the handle. A special category of driven flossing devices is formed by the so-called water flosser or “Waterpik®”, a flossing device on the basis of a high-pressure water jet. Such a water flosser is provided with a small, anatomically formed spray nozzle from which water can be sprayed between the teeth at high pressure.

Also known are electrically driven toothpicks or interdental brushes. Use is made here of small profiled cleaning members which are inserted between teeth and can there be moved reciprocally. These can be slender, elongate plastic bodies with a profile, although slender brushes can also be envisaged. Such brushes are generally conical, so that they have a point which can easily penetrate into an interdental space. The brush can be rotated or moved reciprocally by a drive.

Flossing and using toothpicks or interdental brushes are important cleaning techniques for the interdental spaces. Regular cleaning of these spaces can prevent the formation of dental plaque. Dental plaque is a significant source of early tooth decay, and is partially responsible for causing gum disease. It is therefore important for the interdental spaces to be cleaned regularly by using flossing thread, toothpicks or interdental brushes.

A problem which occurs in driven toothpicks or interdental brushes is that the toothpick or interdental brush can become stuck in the narrow interdental space between two teeth. When the toothpick or interdental brush is driven, a blocking of the movement thereof can result in great forces on the teeth, which can result in damage, injury or in any case pain. In addition, these forces can result in damage to the cleaning member or even to the drive.

The invention now has for its object to provide a teeth-cleaning device of the above described type, wherein said problems do not occur, or at least do so to lesser extent.

According to a first aspect of the invention, this is achieved in that a protection against overloading is arranged between the cleaning member and the drive. Such an overload protection limits the forces which the cleaning member can exert on both the teeth and on the drive, whereby the chance of injury or damage is reduced.

According to an embodiment of the device, the overload protection can comprise a slipping coupling. A slipping coupling can prevent high loads in reliable manner, and can take a structurally fairly simple form.

The slipping coupling is preferably a magnetic coupling. Because use is made of magnetic attractive force, the different parts of the coupling can have smooth surfaces, which is structurally particularly simple. There is furthermore no risk of the coupling parts unintentionally becoming caught on each other. The release of the coupling parts is predictable and reproducible.

When the slipping coupling comprises a magnet connected drivably to the drive and a follower of magnetizable material connected to the cleaning member, the cleaning member, which will become worn after repeated use, can be replaced without the (relatively expensive) magnet having to be discarded.

Although it is possible in principle to envisage that the magnet is an electromagnet which is energized when the drive is switched on, it is preferred that the magnet is a permanent magnet. The drive need thus not be dimensioned to supply the magnetic force.

A relatively firm attachment, also when the volume of the magnet is small, is then achieved when the magnet comprises neodymium. Neodymium is a very strongly magnetic material.

For an optimal cleaning action it is preferred for the cleaning member to be mounted rotatably in the handle and for the drive to comprise a rotatable drive shaft. In that case the magnet of the slipping coupling can advantageously be connected to the drive shaft.

In order to be able to use the handle in combination with different cleaning systems it can be divisible at the position of the magnetic coupling.

For an optimal interdental cleaning the cleaning member can comprise a conical brush.

When the cleaning member is connected releasably to the handle, it can be replaced with a new one after use in simple manner.

A cleaning member can here comprise a flossing thread for a combined dental cleaning, and a pulley around which the flossing thread is wound can be received in or on the handle. The releasable attachment is thus realized in simple manner.

In order to be able to wind the flossing thread around the pulley quickly and effortlessly, the pulley is preferably connected to the drive shaft.

In this case the drive shaft is advantageously rotatable in two directions, so that the flossing thread can also be unwound from the pulley again in order to detach the cleaning member.

The pulley, which has a relatively large surface area, can be manufactured at least partially from a magnetizable material and can function as a follower. A relatively strong attachment to the magnet is thus achieved.

In that case the cleaning member and the pulley can be detachable as a whole.

According to another aspect of the invention, a teeth-cleaning device is provided wherein the drive comprises an electric motor and a rechargeable battery. Such a device can in principle be used anywhere.

When the rechargeable battery is connected to a USB connection on the handle, it can be charged by the same charger as mobile phones, tablets and other electronics, so that a separate charger is not necessary.

For co-action with modern chargers it is then preferred for the USB connection to be a mini USB connection.

In addition or instead, the battery can be inductively chargeable and the handle can be provided with a central recess in its end surface. The device can thus be used in combination with a standard inductive charger for an electric toothbrush, which is provided with a base with an upright pin.

Finally, the invention also relates to a cleaning member which is evidently intended for application in a device as described above.

The invention is now elucidated on the basis of an embodiment, wherein reference is made to the accompanying drawing in which corresponding components have the same reference numerals, and in which:

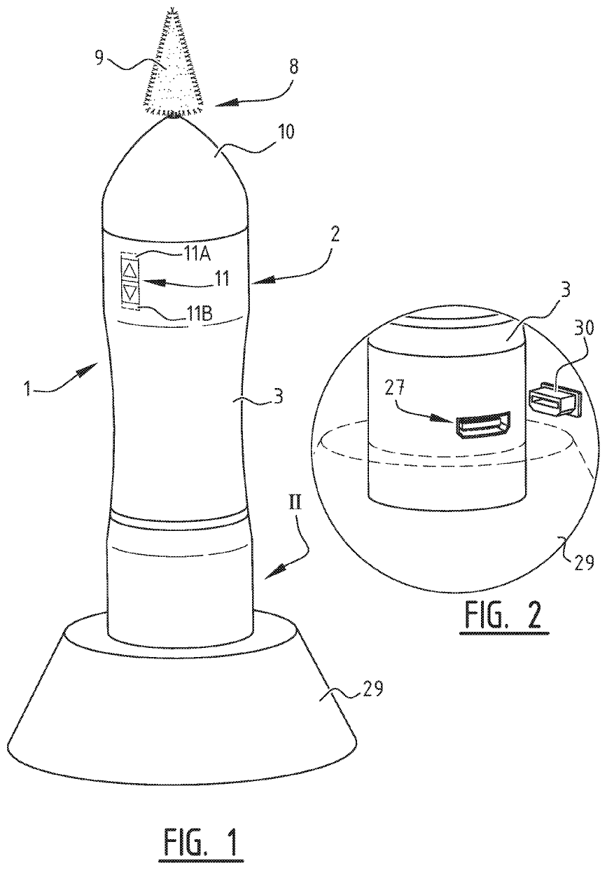

FIG. 1 is a perspective view of a teeth-cleaning device according to the invention,

FIG. 2 is a perspective detail view on enlarged scale as according to arrow II in FIG. 1,

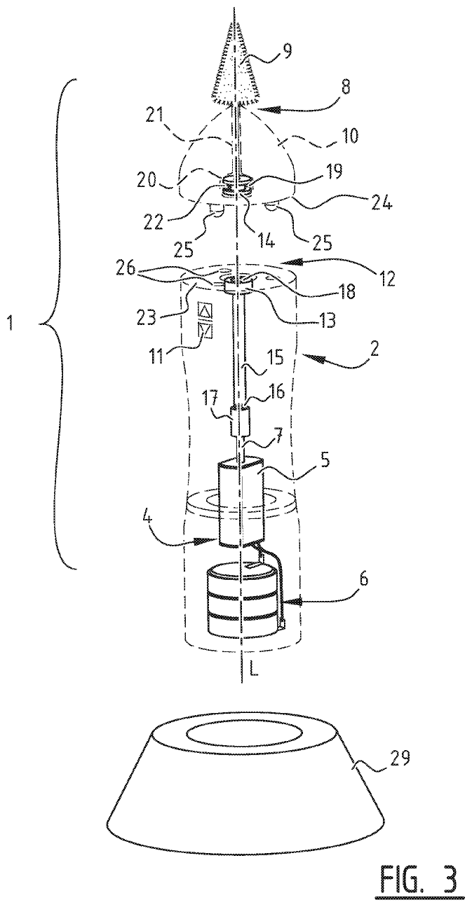

FIG. 3 is a perspective view with exploded parts of the device of FIG. 1, wherein the housing of the handle has been omitted for the sake of clarity,

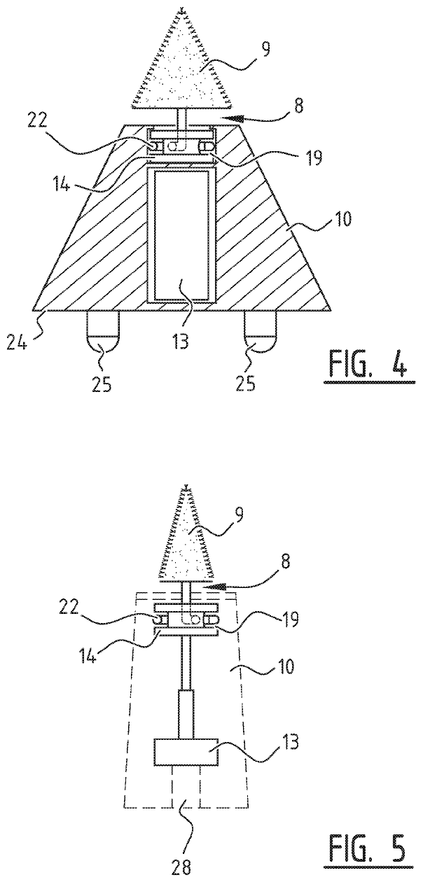

FIG. 4 is a longitudinal section through a part of an alternative embodiment of the device, and

FIG. 5 is a schematic longitudinal section through yet another embodiment of the device.

A device 1 for cleaning a set of teeth comprises a handle 2, here taking the form of a substantially cylindrical body with a rounded top 10. Cylindrical body 2 forms a housing 3 in which a drive 4 is received. In the shown example this drive 4 comprises an electric motor 5 which is powered by a battery 6 and which has an output drive shaft 7. A switch 11 is provided for switching drive 4 on and off. Drive 4 can here be operational in two directions, and switch 11 can thus be controlled, from the shown neutral position in which drive 4 is not operational, in two directions indicated with arrows. The two operative positions 11A, 11B of switch 11 are shown in broken lines.

A cleaning member 8, in the shown example in the form of a conical (interdental) brush 9, is connected movably to handle 2. In the shown example cleaning member 8 is mounted rotatably in handle 2. Cleaning member 8 extends substantially in line with a longitudinal axis L of handle 2, and is rotatable about this longitudinal axis L.

Cleaning member 8 is connected drivably to drive 4. Cleaning member 8 can thus be set into rotation by switching on drive 4, and then be inserted into interdental spaces between the teeth so as to clean them and thus prevent the formation of dental plaque.

In order to prevent the risk of injury or damage when interdental brush 9 of cleaning member 8 unexpectedly experiences a lot of resistance and as it were “jams”, a protection against overloading is arranged between cleaning member 8 and drive 4. In the shown example this overload protection comprises a slipping coupling 12.

Although there are different ways of embodying a slipping coupling, in the shown example a magnetic coupling has been opted for. In the shown example this magnetic slipping coupling 12 comprises a magnet 13 which is connected drivably to drive 4 and a follower 14 of magnetizable material which is connected to cleaning member 8. In the shown embodiment magnet 13 is annular and is arranged on a shaft part 15, for instance of plastic, which is provided on its end lying opposite magnet 13 with screw thread 16. This screw thread forms a connection to a bushing 17 with internal screw thread which is fastened onto drive shaft 7. Magnet 13 is fixed relative to shaft 15 by means of a screw 18.

In the shown example magnet 13 is a permanent magnet, for instance a neodymium magnet. As stated, follower 14 is manufactured from a magnetizable material, for instance iron.

Follower 14 here takes the form of a pulley with an upper and lower disc, and a groove 19 formed therebetween, and a central infeed opening for a thread, which debouches in groove 19. The pulley is mounted rotatably in a space 20 in an upper part 10 of handle 2. From this space 20, a channel 21 extends to the outer end of handle 2. Wound in the groove 19 of the pulley is an outer end of a flossing thread 22, the other end of which is guided through channel 21 and is attached to the conical (interdental) brush 9 of cleaning member 8. By winding the flossing thread 22 tightly onto the pulley the interdental brush 9 is pulled against the outer end of handle 2, whereby cleaning member 8 is firmly attached.

When drive 4 is switched on, drive shaft 7 and the shaft part 15 attached thereto rotate, and thereby thus also magnet 13. Follower 14 co-rotates with magnet 13, and this rotation is transmitted via shaft part 15 to interdental brush 9. When this interdental brush 9 experiences an unexpectedly great resistance, follower 14 will lag relative to rotating magnet 13, and thus begin to slip. This prevents overloading.

Handgrip 2 is divided at the position of slipping coupling 12. Co-acting coupling means arc formed in an upper surface 23 of the cylindrical part of handle 2 and in a lower surface 24 of upper part 10. In the shown example these coupling means can take the form of pins 25 which protrude from lower surface 24 and which can be received in openings 26 in upper surface 23. Owing to these co-acting pins 25 and openings 26, upper part 10 is connected non-rotatably to the cylindrical part of handle 2. In addition, the two parts are drawn together by the magnetic force between magnet 13 and follower 14. A user can pull upper part 10 off the cylindrical part and for instance exchange it for another upper part with a different type of cleaning member.

In addition, a user can exchange cleaning member 8 by reversing the rotation direction of drive 4 using switch 11. Flossing thread 22 is then unwound from the pulley again, after which cleaning member 8 can be detached from the handle. In order to mount a new cleaning member the flossing thread 22 connected thereto once again has to be guided through channel 21 and to the pulley, and carried via the infeed opening into groove 19. By operating switch 11 the drive 4 can then be started and flossing thread 22 can be wound around the pulley.

FIG. 4 shows an alternative embodiment of upper part 10, wherein a cylindrical neodymium magnet 13 is received in this upper part, which has the form of a truncated cone. Just as in the first embodiment, this magnet co-acts with a follower 14 of magnetizable material, once again in the form of a pulley. In this example the (interdental) brush 9 is pulled substantially directly against pulley 14 via a short piece of flossing thread 22. In this embodiment the drive shaft and the extension piece placed thereon can be made wholly of metal or plastic, as long as it ends close to upper surface 23 in a part of magnetizable material. Two magnetic connections, to follower 14 on the one hand and drive shaft 7 and its extension piece 15 on the other, are thus formed on either side of magnet 13.

FIG. 5 shows an embodiment which is suitable to be connected to the handle of a conventional electric toothbrush. Device 1 is here for this purpose in effect limited to the upper part 10, in which a recess 28 is arranged on the underside. Into this recess 28 can be inserted the output shaft of a conventional electric toothbrush, which then moves the magnet 13 along with it. The magnet in turn moves along with it the follower/pulley 14, to which interdental brush 9 is attached by means of the flossing thread 22 wound around the pulley.

In contrast to conventional electric toothbrushes, which are generally provided with a battery which can be charged via either a direct connection to the mains electricity or an inductive connection to a base which is connected to the mains electricity, in the device according to the invention a power supply by means of a USB connection 27 is provided for. This can be a conventional USB connection, as shown, but also a mini USB connection. This has the advantage that the device can be powered by equipment which is generally already available for the purpose of powering for instance mobile phones, tablets and the like. The base 29 can hereby moreover take a very simple form, because no electrical components need be incorporated therein. Because device 1 will usually be used in wet spaces, the USB connection can be scaled watertightly by a rubber cap 30.

Although the invention has been elucidated above on the basis of a number of examples, it will be apparent that it is not limited thereto and can be varied in many ways. The slipping coupling could thus be embodied other than with magnets, for instance by a mechanical connection on the basis of friction and elasticity. The manner in which the attachment of the cleaning member to the handle is realized can also be adapted, and the principle of power supply via a USB connection is not limited to the type of teeth-cleaning device described here but can be applied in all manner of electrical appliances, particularly travel appliances.

The scope of the invention is therefore defined solely by the following claims.

1. Device for cleaning a set of teeth, comprising a handle, a drive arranged on or in the handle and a cleaning member connected movably to the handle and drivably to the drive, characterized in that a protection against overloading is arranged between the cleaning member and the drive.

2. Device as claimed in claim 1, characterized in that the overload protection comprises a slipping coupling.

3. Device as claimed in claim 2, characterized in that the slipping coupling is a magnetic coupling.

4. Device as claimed in claim 3, characterized in that the slipping coupling comprises a magnet connected drivably to the drive and a follower of magnetizable material connected to the cleaning member.

5. Device as claimed in claim 4, characterized in that the magnet is a permanent magnet.

6. Device as claimed in claim 5, characterized in that the magnet comprises neodymium.

7. Device as claimed in claim 1, characterized in that the cleaning member is mounted rotatably in the handle and the drive comprises a rotatable drive shaft.

8. Device as claimed in claim 4, characterized in that the magnet is connected to the drive shaft.

9. Device as claimed in claim 3, characterized in that the handle is divisible at the position of the magnetic coupling.

10. Device as claimed in claim 1, characterized in that the cleaning member comprises a conical brush.

11. Device as claimed in claim 1, characterized in that the cleaning member is connected releasable to the handle.

12. Device as claimed in claim 11, characterized in that the cleaning member comprises a flossing thread and a pulley around which the flossing thread is wound is received in or on the handle.

13. Device as claimed in claim 7 characterized in that the pulley is connected to the drive shaft.

14. Device as claimed in claim 13, characterized in that the drive shaft is rotatable in two directions.

15. Device as claimed in claim 8 characterized in that the pulley is manufactured at least partially from a magnetizable material and functions as a follower.

16. Device as claimed in claim 15, characterized in that the cleaning member and the follower are detachable as a whole.

17. Device as claimed in any one of the foregoing claims or as claimed in the preamble of claim 1, characterized in that the drive comprises an electric motor and a rechargeable battery.

18. Device as claimed in claim 17, characterized in that the rechargeable battery is connected to a USB connection on the handle.

19. Device as claimed in claim 18, characterized in that the USB connection is a mini USB connection.

20. Cleaning member, evidently intended for application in a device as claimed in claim 1.
